(19) United States
(12) Patent Application Publication
(10) Pub. No.: US 2006/0291674 A1
(43) Pub. Date: Dec. 28, 2006

(54) Method of making silicon-based miniaturized microphones

(75) Inventors: Shih-Chin Gong, Taipei City (TW); Zhong-Yuan Lin, Taichung County (TW); Yao-Min Huang, Taoyuan County (TW); Cyuan-Sian Cheng, Miaoli County (TW); Shu-Yuan Hsue, Taipei County (TW)

Correspondence Address: BROWDY AND NEIMARK, P.L.L.C.;624 NINTH STREET, NW, SUITE 300, WASHINGTON, DC, 20001-5303, US

(73) Assignee: Merry Electronics Co. Ltd., Taichung (TW)

(21) Appl. No.: 11/151,460

(22) Filed: Jun. 14, 2005

(51) Int. Cl. H04R 25/00

(52) U.S. Cl. 381/174

(57) ABSTRACT

A method of making a silicon-based miniaturized microphone by means of the application of a combination of processes including a semiconductor manufacturing process and a silicon micro-machining technology. A silicon-based miniaturized microphone made by means of this method has a silicon substrate, which defines a resonance cavity, a diaphragm, a backplate having sound holes, and solder pads. This method is easy to perform, and suitable for a mass production to reduce the manufacturing cost.

### BACKGROUND OF THE INVENTION

1. Field of the Invention

The present invention relates to miniaturized microphones and more particularly, to a method of making silicon-based miniaturized microphone, which is practical for making high sensitivity and high reliability miniaturized thin type microphones through a mass production.

2. Description of the Related Art

It is the market tendency to provide compact and sophisticated mobile electronic devices such as MP3 players, cell phones, PDAs, etc. A microphone is an important part commonly seen in regular mobile electronic devices. It is important to provide a high-performance microphone having light, thin, short and small characteristics.

FIG. 1 shows a miniaturized microphone 7 constructed according to U.S. Pat. No. 5,573,679. According to this design, the diaphragm 71 and backplate 72 of the microphone 7 are respectively made by silicon nitride. Because silicon nitride is electrically insulative, electrically conductive layers 73 and 74 must be provided at the diaphragm 71 and the backplate 72 to work as electrodes. These electrically conductive layers 73 and 74 relatively increase the size and manufacturing cost of the microphone 7.

FIG. 2 shows a miniaturized microphone 8 constructed according to U.S. Pat. No. 5,888,845. According to this design, epitaxy wafers are used to make the diaphragm 81 of the microphone 8. Therefore, the material cost of this structure of microphone 8 is high. Further, the backplate 82 of the microphone 8 is made by using a metal layer 83 as a seed layer and then using a micro plating technique to form a metal thick film 84 on the top surface of the metal layer 83 to enhance the stiffness of the backplate. However, it is difficult to control the uniformity of the thickness of the metal thick film 84. Further, because the backplate has no passivation for protection, the quality of the product is not guaranteed.

FIG. 3 shows a miniaturized microphone 9 constructed according to U.S. Pat. No. 6,140,689. According to this design, the microphone 9 has the backplate 92 set at an inner side and the diaphragm 91 set at the outer side. Further, because the diaphragm 91 has a small thickness, it tends to be affected by external environmental conditions. Due to the said drawbacks, the yield rate of this design is low.

Therefore, it is desirable to provide a method of making microphone, which is practical for making miniaturized, high-performance microphones at a high yield rate.

### SUMMARY OF THE INVENTION

The present invention has been accomplished under the circumstances in view. It is the primary objective of the present invention to provide a method of making silicon-based miniaturized microphone, which is practical for making high sensitivity and high reliability miniaturized microphones.

It is another objective of the present invention to provide a method of making silicon-based miniaturized microphone, which is practical for mass production of high sensitivity and high reliability miniaturized microphones to reduce the manufacturing cost.

To achieve these objectives of the present invention, the method of making a silicon-based miniaturized microphone comprising the steps of: a) preparing a silicon substrate having a dielectric layer respectively covered on top and bottom surfaces thereof and depositing a polysilicon material on the dielectric layer at the top surface of the silicon substrate to form a diaphragm, and then doping the diaphragm with baron ions or phosphor ions, and then annealing the diaphragm, and then etching the diaphragm by a photo lithographic process subject to a predetermined pattern; b) depositing a sacrificial layer on the diaphragm; c) depositing an insulative layer on the sacrificial layer; d) depositing a polysilicon film on the insulative layer and then doping the polysilicon film with baron ions or phosphor ions and then annealing the polysilicon film to form a backplate, and then etching the backplate subject to a predetermined pattern; e) depositing a passivation on the backplate and then etching the passivation to provide a contact window; f) using a sputtering coating technology or an evaporation coating technology to form two solder pads, which are respectively and electrically connected to the backplate and the diaphragm, within the contact window; g) etching the passivation, the backplate and the insulative layer, so as to form a plurality of sound holes; h) stripping off the dielectric layer at the bottom surface of the silicon substrate, and then etching the silicon substrate, and then stripping off a part of the dielectric layer at the top surface of the silicon layer so as to form a resonance cavity; and i) stripping off the sacrificial layer.

### BRIEF DESCRIPTION OF THE DRAWINGS

FIG. 1 is a schematic drawing showing the structure of a miniaturized microphone according to the prior art.

FIG. 2 is a schematic drawing showing another structure of miniaturized microphone according to the prior art.

FIG. 3 is a schematic drawing showing still another structure of miniaturized microphone according to the prior art.

FIGS. 4A-4I show a silicon-based miniaturized microphone processing process according to a preferred embodiment of the present invention.

FIG. 5 is a schematic drawing showing the structure of a silicon-based miniaturized microphone constructed according to another preferred embodiment of the present invention.

FIG. 6 is a schematic drawing showing an alternate form of the silicon-based miniaturized microphone constructed according to the present invention.

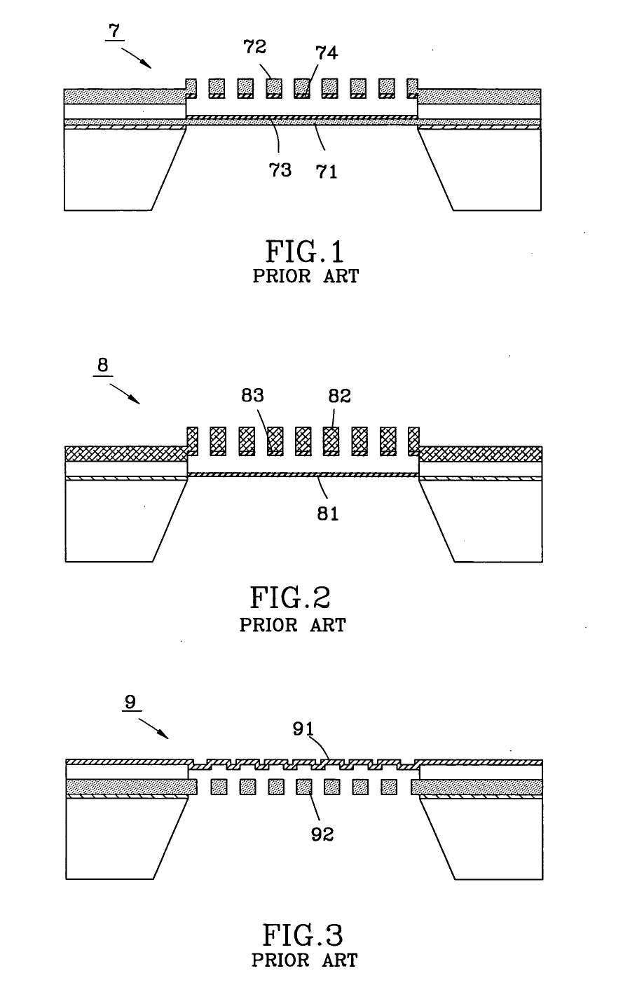

### DETAILED DESCRIPTION OF THE INVENTION

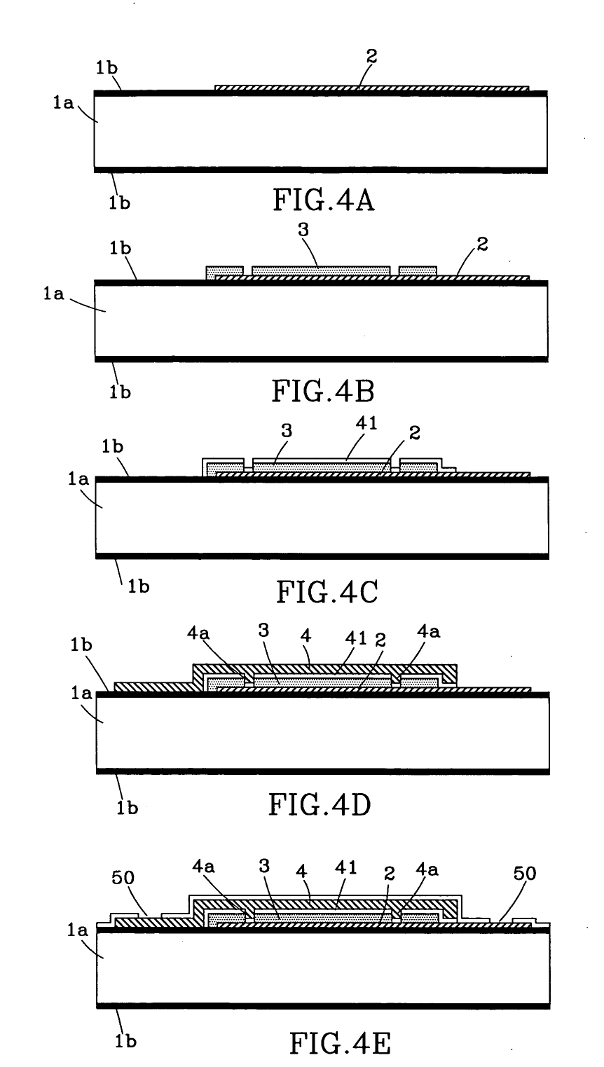

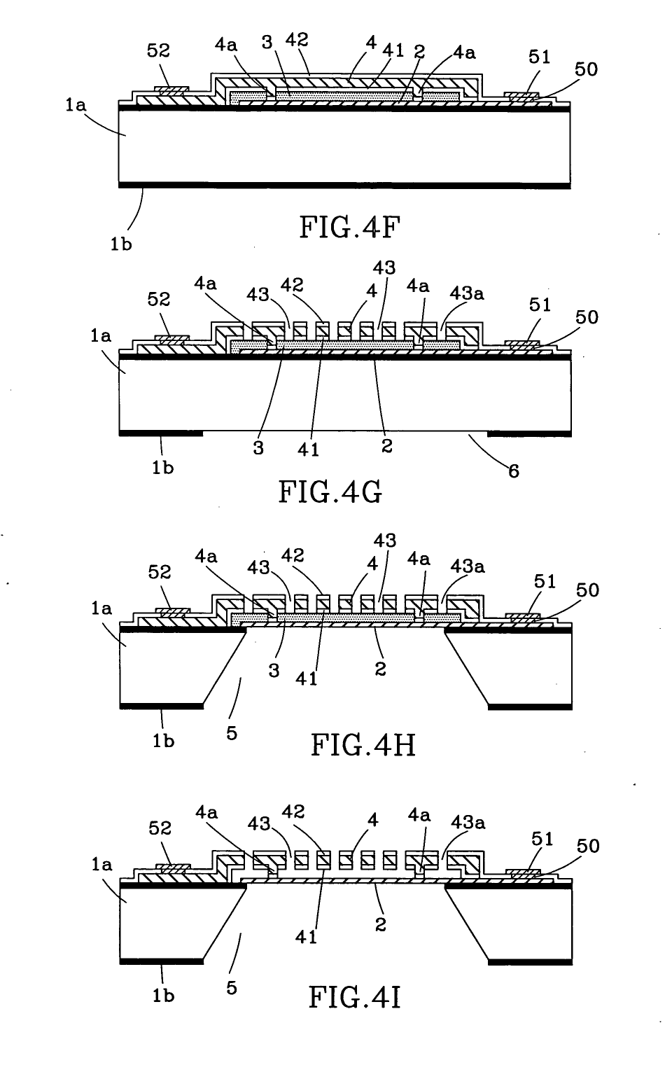

Referring to FIG. 4I, a silicon-based miniaturized microphone 1 is shown comprised of a silicon substrate 1a, a backplate 4, a diaphragm 2, and two metal solder pads 51, 52.

As shown in FIGS. 4A-4I, the method of making the aforesaid silicon-based miniaturized microphone 1 comprises the steps of:

a) preparing a N type or P type silicon substrate 1a having the crystal orientation <100> and a dielectric layer 1b of silicon dioxide or silicon nitride respectively covered on the top and bottom surfaces, and depositing a polysilicon material in the dielectric layer 1b at the top side of the silicon substrate 1a by a low pressure CVD (Chemical Vapor Deposition) process to form a diaphragm 2, and then doping the diaphragm 2 with baron ions or phosphor ions, and then annealing the diaphragm 2 to form a P type or N type, low stress, semiconductor diaphragm of thickness about 0.1-0.4 μm, for enabling of processing the diaphragm with a photo lithographic process to have the designed pattern (see FIG. 4A);

b) growing a sacrificial layer 3 of LTO (Low Temperature Oxide), for example, PSG (phosphorous silicon glass) about 0.5-5.0 μm thick from the diaphragm 2 by a low pressure CVD or PECVD (Plasma Enhanced Chemical Vapor Deposition) process, and then employing a photo lithographic process (see FIG. 4B), where LOT is used for the sacrificial layer 3 for the advantage of relatively lower density relative to HTO (High Temperature Oxide) for rapid etching and further silicon micro-machining (see FIG. 4B);

c) growing an insulative layer 41 of silicon nitride having a thickness about 0.1-2.0 μm from the sacrificial layer 3 by a low pressure CVD or PECVD (Plasma Enhanced Chemical Vapor Deposition) process (see FIG. 4C);

d) growing a polysilicon film having a thickness about 1.0-6.0 μm from the top surface of the insulative layer 41 by a low pressure CVD (Chemical Vapor Deposition) process, and then doping the polysilicon film with baron ions or phosphor irons and then annealing the film to form a backplate 4 having protruding structures 4a, and then etching the backplate 4 subject to the desired pattern (see FIG. 4D);

e) growing a passivation 42 of silicon nitride of thickness about 0.1-2.0 μm from the top surface of the backplate 4 by a low pressure CVD or PECVD (Plasma Enhanced Chemical Vapor Deposition) process to provide the effects of protection, electricity insulation and stiffness reinforcement, and then etching the passivation 42 by photo lithography to provide contact windows 50 (see FIG. 4E);

f) using a semiconductor sputtering or evaporation coating technology to cover the top side of the backplate 4 with a layer of metal material, for example, aluminum, gold, chrome, platinum, titanium, nickel, copper, silver, or the alloy thereof of thickness about 0.1-1.5 μm, and then using a semiconductor lift-off or wet etching technology to define the pattern of the metal coating, so as to form two solder pads 51 and 52 within the contact windows 50 that are respectively electrically connected to the backplate 4 and the diaphragm 2 (see FIG. 4F);

g) using a lithographic technology to define the pattern, and then using an etching technology to etch the passivation 42, the backplate 4 and the insulator layer 41 subject to the defined pattern, so as to form a plurality of sound holes 43 and etching holes 43a (see FIG. 4G);

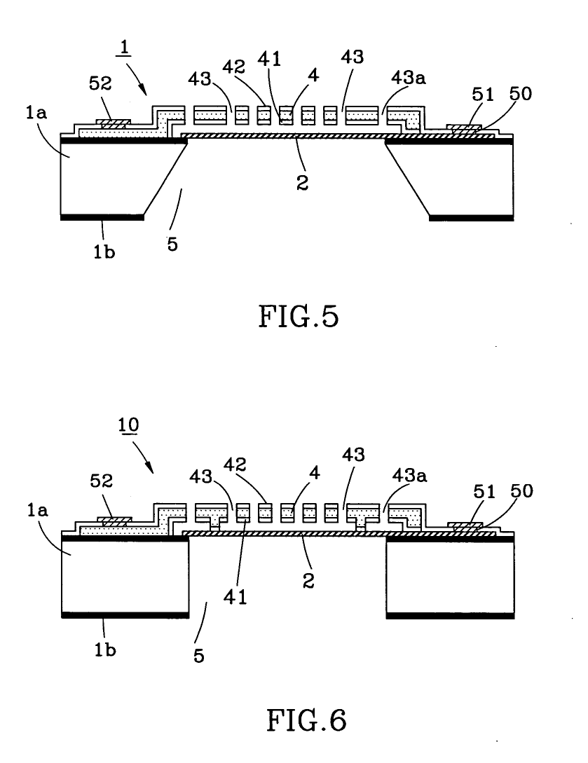

h) using a photo lithographic technology to define an etching window 6 at the bottom side of the silicon substrate 1a (see FIG. 4G), and then using the dielectric layer of the silicon substrate 1a as an etching mask to selectively etch the etching window 6 with KOH or TMAH solution by an anisotropic chemical wet etching process to form a notch 5, and then stripping off the dielectric layer 1b from the top side of the silicon substrate 1a so that the notch 5 forms a resonance cavity 5 and the diaphragm 2 is kept suspending in the resonance cavity 5 (see FIG. 5H); and

i) using HF (Hydrofluoric Acid), BOE (Buffered Oxide Etchant), or HF (Hydrofluoric Acid) vapor to strip off the sacrificial layer 3 (see FIG. 41), thereby obtaining the desired silicon-based miniaturized microphone 1.

Referring to FIG. 4I again, the silicon-based miniaturized microphone 1 has arranged one above another in proper order the silicon substrate 1a, the diaphragm 2, the insulative layer 41, the backplate 4, the passivation 42, and the two solder pads 51 and 52, wherein the silicon substrate 1a defines a resonance cavity 5; the insulative layer 41 and the backplate 4 and the passivation 42 define a plurality of sound holes 43.

Therefore, the backplate 4 and diaphragm 2 of the silicon-based miniaturized microphone 1 work as top and bottom electrodes such that vibration of the diaphragm 2 upon a sound pressure causes a variation of the capacitance value.

Further, the protruding structure 4a of the backplate 4 of the silicon-based miniaturized microphone 1 prevents stiction between the diaphragm 2 and the backplate 4, thereby improving the yield rate of the product.

Further, when employing another anti-stiction technology to strip off the sacrificial layer 3 during step i), for example, sacrificial layer dry etching, hydrofluoric acid vapor etching, or organic drying technology, the design of the protruding structure 4a can be eliminated, thereby obtaining another structure of silicon-based miniaturized microphone 10 as shown in FIG. 5.

In the aforesaid first preferred embodiment of the present invention, an anisotropic chemical wet etching process is employed to etch the etching window 6 to form a resonance cavity 5 having the <111> orientation of the peripheral walls during step h). An ICP (Inductively Coupled Plasma) etching process may be employed instead of the anisotropic chemical wet etching process, thereby forming a resonance cavity 55 having vertical peripheral walls as shown in FIG. 6.

Therefore, changing the aforesaid steps (h) and (i) can obtain another structure of silicon-based miniaturized microphone 20 as shown in FIG. 6.

The silicon-based miniaturized microphone manufacturing process of the present invention is a combination of a semiconductor manufacturing process and a silicon micro-machining technology. Although particular embodiments of the invention have been described in detail for purposes of illustration, various modifications and enhancements may be made without departing from the spirit and scope of the invention. Accordingly, the invention is not to be limited except as by the appended claims.

What is claimed is:

1. A method of making a silicon-based miniaturized microphone comprising the steps of:
a) preparing a silicon substrate having a dielectric layer respectively covered on top and bottom surfaces thereof and depositing a polysilicon material on the dielectric layer at the top surface of said silicon substrate to form a diaphragm, and then doping said diaphragm with ions selected from a group consisting of baron ions and phosphor ions, and then annealing said diaphragm, and then etching said diaphragm by a photo lithographic process subject to a predetermined pattern;
b) depositing a sacrificial layer on said diaphragm;
c) depositing an insulative layer on said sacrificial layer;
d) depositing a polysilicon film on said insulative layer and then doping the polysilicon film with ions selected from a group consisting of baron ions and phosphor ions and then annealing the polysilicon film to form a backplate, and then etching said backplate subject to a predetermined pattern;
e) depositing a passivation on said backplate and then etching said passivation to provide a contact window;
f) using a coating technology selected from a group consisting of a sputtering coating technology and an evaporation coating technology to form two solder pads, which are respectively and electrically connected to said backplate and said diaphragm, within said contact window;
g) etching said passivation, said backplate and said insulative layer, so as to form a plurality of sound holes;
h) stripping off the dielectric layer at the bottom surface of said silicon substrate, and then etching said silicon substrate, and then stripping off a part of the dielectric layer at the top surface of said silicon layer so as to form a resonance cavity; and
i) stripping off said sacrificial layer.

2. The method of making a silicon-based miniaturized microphone as claimed in claim 1, wherein the dielectric layers at the top and bottom surfaces of said silicon substrate are made from a material selected from a group consisting of silicon dioxide and silicon nitride.

3. The method of making a silicon-based miniaturized microphone as claimed in claim 1, wherein said diaphragm has a thickness ranging from about 0.1 to 4.0 μm.

4. The method of making a silicon-based miniaturized microphone as claimed in claim 1, wherein said sacrificial layer is made from a material selected from a group consisting of low temperature oxide and phosphorous silicon glass.

5. The method of making a silicon-based miniaturized microphone as claimed in claim 1, wherein said sacrificial layer has a thickness ranging from about 0.5 to 5.0 μm.

6. The method of making a silicon-based miniaturized microphone as claimed in claim 1, wherein said insulative layer is made from silicon nitride.

7. The method of making a silicon-based miniaturized microphone as claimed in claim 1, wherein said insulative layer has a thickness ranging from about 0.1 to 2.0 μm.

8. The method of making a silicon-based miniaturized microphone as claimed in claim 1, wherein said backplate has a thickness ranging about 1.0 to 6.0 μm.

9. The method of making a silicon-based miniaturized microphone as claimed in claim 1, wherein said passivation is made from silicon nitride.

10. The method of making a silicon-based miniaturized microphone as claimed in claim 1, wherein said solder pads are made from a metal selected from a group consisting of aluminum, gold, chrome, platinum, titanium, nickel, copper, and silver.

11. The method of making a silicon-based miniaturized microphone as claimed in claim 1, wherein said solder pads have a thickness raging about 0.1 to 1.5 μm.

12. The method of making a silicon-based miniaturized microphone as claimed in claim 1, wherein the depositing technique used is selected from a group consisting of low pressure chemical vapor deposition technique and plasma enhanced chemical vapor deposition technique.

13. The method of making a silicon-based miniaturized microphone as claimed in claim 1, wherein the process of etching said silicon substrate to form said resonance cavity is performed through an etching technique selected from a group consisting of an anisotropic chemical wet etching technology and an inductively coupled plasma dry etching technology.

14. The method of making a silicon-based miniaturized microphone as claimed in claim 1, wherein the step i) of stripping off said sacrificial layer is done by means of performing a chemical wet etching process with the use of an etchant selected from a group consisting of HF (Hydrofluoric Acid) and BOE (Buffered Oxide Etchant).

15. The method of making a silicon-based miniaturized microphone as claimed in claim 14, wherein the step i) of stripping off said sacrificial layer includes an organic drying process employed after the chemical wet etching process.

16. The method of making a silicon-based miniaturized microphone as claimed in claim 1, wherein said step i) of stripping off said sacrificial layer is done by means of performing a dry etching technology selected from a group consisting of hydrofluoric acid vapor etching technology and isotropic inductively coupled plasma dry etching technology.
